(19) United States
(12) Patent Application Publication
(10) Pub. No.: US 2007/0267330 A1
(43) Pub. Date: Nov. 22, 2007

(54) Agricultural Product Cleaning and Sorting System

(76) Inventor: Shinichi Mukai, Kingsburg, CA (US)

Correspondence Address: LAW OFFICE OF PHILIP A STEINER, 1212 MARSH STREET, SUITE 3, SAN LUIS OBISPO, CA, 93401, US

(21) Appl. No.: 11/419,743

(22) Filed: May 22, 2006

(51) Int. Cl. B07B 9/00; B07B 1/04

(52) U.S. Cl. 209/359; 209/21

(57) ABSTRACT

A mobile agricultural product treatment system for cleaning and sorting generally granular agricultural products such as raisins, seeds, nuts, grapes and the like. In an embodiment, a conveyor belt transports agricultural product into an inlet hopper for treatment by the pneumatic cleaning unit. The treated agricultural product is discharged from the pneumatic cleaning unit onto a vibratory sorting unit. The vibratory sorting unit includes several screens arranged in increasing mesh size to sort from smaller to larger agricultural products. The sorted agricultural product is collected by downwardly sloping conduits. In an embodiment, the conduits include a screw conveyor. The conduits feed into a series of vertical screw conveyors which lifts the product up to a high point into a downwardly sloping horizontal conduit. In an embodiment, the discharge from the horizontal conduit is routed through a flexible duct to allow for positioning of collection bins. In an embodiment, a multilayer field drying and transport medium is provided which is retracted after field treatment by a transfer unit. The transfer unit receives the field drying and transport medium onto a retraction spool. The retraction spool includes one or more vertically oriented cutting blades which longitudinally bisect the field drying and transport medium, allowing the agricultural product to free fall into the field collection bin used to feed the stair-step type conveyor unit.

### CROSS-REFERENCE TO RELATED APPLICATIONS

Not Applicable

### FEDERALLY SPONSORED RESEARCH AND DEVELOPMENT

Not Applicable

### REFERENCE TO A MICROFICHE APPENDIX

Not Applicable

### FIELD OF INVENTION

The present invention relates generally to a field treatment unit used in the agricultural industry and more specifically to a mobile pneumatic cleaning and sorting unit for field treatment of nuts, grapes, raisins, seeds and like granular agricultural products.

### BACKGROUND

Removal of contaminants from agricultural products such as nuts, grapes, seeds, and raisins is a time consuming and inefficient process. In general, a mechanical harvester is used to remove the agricultural products from the plant or tree followed by a field treatment process in which the agricultural products are dried by the sun. The field drying technique allows the accumulation of additional contaminants carried by the wind, birds and animals to be deposited among the drying agricultural products. Once the drying process has been completed, the agricultural product is transported to a central processing plant. The central processing plant requires expensive equipment to remove remaining contaminants and substandard product not suitable for human consumption. This increases the cost to the grower as the product must be transported in bulk to the central processing plant. The contaminants and unsuitable product may account for a substantial fraction of the bulk weight of the agricultural product being transported to the central processing plant, thus adding to the handling, transportation and processing costs. To reduce the handling, sorting, transportation and processing costs, a mobile cleaning and sorting unit which does not require significant labor or use large quantities of water is highly desirable.

In addition, a drying arrangement which reduces the collection of contaminants and product loss due to birds, insects and animals and is compatible with current harvesting techniques is likewise highly desirable.

### SUMMARY

Various embodiments described herein address the desirable aspects lacking in the relevant art and provides in the various embodiments an mobile agricultural product treatment system. In a first systematic embodiment, the system comprises an agricultural product transport unit having an outlet disposed above an inlet hopper coupled to a pneumatic cleaning unit. The inlet hopper is configured to receive the agricultural product for delivery into an intake of the pneumatic cleaning unit. The pneumatic cleaning unit is mounted above a vibratory cleaning unit and includes a discharge hopper disposed above a longitudinal end of the vibratory cleaning unit.

The vibratory cleaning unit includes a plurality of sorting screens disposed periodically along a generally horizontal longitudinal axis. The sorting screens are arranged sequentially in increasing mesh sizes.

A number of declining laterally aligned collection conduits mounted below the plurality of sorting screens are configured to receive the sorted agricultural product which is delivered to a plurality of screw lift conveyers. Each of the screw lift conveyers are coupled to a low end of the collection conduits.

In addition, each of the screw lift conveyers comprises a generally vertical conduit rotationally coupled by a swivel joint at an upper end to a generally declining horizontal conduit forming an inverted “L” shaped overhead product discharge duct for delivering the sorted agricultural product to a collection container. The discharge duct may be rotated about a vertical axis using the swivel joint to allow for changing of the discharge collection site. In a related embodiment, each of the generally declining horizontal conduits includes a generally vertically aligned flexible duct coupled to a discharge end of the generally declining horizontal conduit.

In an embodiment, a motive force unit is provided having sufficient capacity when coupled to a drive train to provide the agricultural product cleaning system with self-propulsion. In another related embodiment, the motive force unit further includes sufficient capacity to at least drive the pneumatic and the vibratory cleaning units and the vertical screw conveyors.

In a further embodiment, the agricultural product transport unit comprises a first laterally mounted retraction spool disposed above the inlet hopper and means for at least bifurcating a multi-layered elongated container such that the agricultural product disposed within the container is gravity fed into the inlet hopper. The means for at least bifurcating the multi-layered elongated container includes a cutting blade, precut tear points embedded in the container's top layer and a combination thereof.

The multi-layered elongated container comprises a first layer of perforated polymeric material coupled to a base paper material such that an inner surface of the perforated polymeric material and a top surface of the base paper material form a generally continuous compartment sufficient to maintain the agricultural product stored inside the compartment along a substantial length of the container. In another related embodiment, the multi-layered elongated container comprises an elongated paper sheet base and a perforated clear plastic cover sheet affixed to the elongated paper sheet base such that the agricultural product is disposed within the compartment for field drying.

In a further embodiment, a second retraction spool is laterally mounted below and generally in parallel to the first laterally mounted retraction spool; such that the first retraction spool rotationally receives the perforated polymeric material and the second retraction spool rotationally receives the base paper material. In a related embodiment, the agricultural product transport unit further includes an inclined conveyor belt longitudinally aligned in an axis in common with a direction of travel of the multi-layered elongated container.

In alternate embodiment, the agricultural product transport unit includes an inclined stair-step conveyor belt configured to receive the agricultural product at a low end and transport the agricultural product to the inlet hopper.

In another embodiment, the vibratory cleaning unit further includes a conveyor belt disposed below the discharge hopper and configured to longitudinally transport discharged agricultural product toward an opposite longitudinal end of the vibratory cleaning unit. In a related embodiment, the vibratory cleaning unit further includes a declination at least extending a longitudinal dimension which encompasses the plurality of sorting screens.

In a second systematic embodiment, an mobile agricultural product treatment system is provided which comprises; a first laterally mounted retraction spool rotationally disposed above an inlet hopper. In this embodiment, the inlet hopper is configured to receive agricultural product transported by the at least one retraction spool for entry into an intake of a pneumatic cleaning unit.

The pneumatic cleaning unit is mounted superjacent to a vibratory cleaning unit and includes a discharge hopper disposed above a longitudinal end of the vibratory cleaning unit. The vibratory cleaning unit includes a number of sorting screens disposed periodically along a generally declining horizontal longitudinal axis in sequentially increasing mesh sizes.

A number of laterally aligned and declining collection conduits are mounted below the sorting screens and are configured to receive and deliver the sorted agricultural product to a number of screw lift conveyers. Each screw lift conveyer is coupled at a low end of each of the collection conduits.

Each of the plurality of screw lift conveyers comprises a generally vertical conduit rotationally coupled at an upper end by a swivel joint to a generally declining horizontal conduit forming an inverted “L” shaped overhead product discharge duct. A generally vertically aligned flexible duct is coupled to a discharge end of the generally declining horizontal conduit is provided.

In an embodiment, the first laterally mounted retraction spool at least includes means for at least bifurcating a multi-layered elongated container such that the agricultural product contained therein is gravity fed into the inlet hopper. In a related embodiment, the multi-layered elongated container comprises a first layer of perforated polymeric material coupled to a base paper material such that an inner surface of the perforated polymeric material and a top surface of the base paper material forms a generally continuous compartment sufficient to maintain the agricultural product internally along a substantial length of the multi-layered elongated container.

A further embodiment includes a second retraction spool laterally mounted below and generally in parallel to the first laterally mounted retraction spool; such that the first retraction spool rotationally receives the perforated polymeric material and the second retraction spool rotationally receives the base paper material.

Another further embodiment comprises an inclined conveyor belt aligned in juxtaposition to an axis in common with a direction of travel of the multi-layered elongated container.

In another embodiment, motive force means is provided for at least one of; self propulsion, operation of the pneumatic cleaning unit, vibratory sorting unit and the plurality of screw lift conveyers.

### BRIEF DESCRIPTION OF DRAWINGS

The features and advantages of the invention will become apparent from the following detailed description when considered in conjunction with the accompanying drawings. Where possible, the same reference numerals and characters are used to denote like features, elements, components or portions of the invention. Optional or hidden components or features are generally shown in dashed or dotted lines. It is intended that changes and modifications can be made to the described embodiment without departing from the true scope and spirit of the subject invention as defined in the claims.

FIG. 1—depicts a generalized side view of an embodiment of a mobile agricultural product treatment system.

FIG. 1A—depicts a partial perspective view of an embodiment of a mobile agricultural product treatment system.

FIG. 1B—depicts a partial side view of an embodiment of a mobile agricultural product treatment system.

FIG. 1C—depicts a partial rear view of an embodiment of a mobile agricultural product treatment system with references to various cross sectional views.

FIG. 1D—depicts a partial top view of an embodiment of a mobile agricultural product treatment system viewed from the uppermost level.

FIG. 1E—depicts a partial top view of an embodiment of a mobile agricultural product treatment system viewed from a level below the uppermost level.

FIG. 1F—depicts a partial top view of an embodiment of a mobile agricultural product treatment system viewed from two levels below the uppermost level.

FIG. 1G—depicts a partial top view of an embodiment of a mobile agricultural product treatment system viewed from three levels below the uppermost level.

FIG. 1H—depicts a partial top view of an embodiment of a mobile agricultural product treatment system viewed from four levels below the uppermost level.

FIG. 2—depicts a front perspective view of a product transport unit.

FIG. 3—depicts a partial perspective view of a product transfer unit embodiment

FIG. 4—depicts a partial cross sectional view of an embodiment of a transport medium container.

### DETAILED DESCRIPTION

Various embodiments are provided of a mobile agricultural product treatment system for cleaning and sorting generally granular agricultural products such as raisins, seeds, nuts, grapes and the like. In an embodiment, a multilayer field drying and transport medium is provided which is retracted after field treatment by a transfer unit.

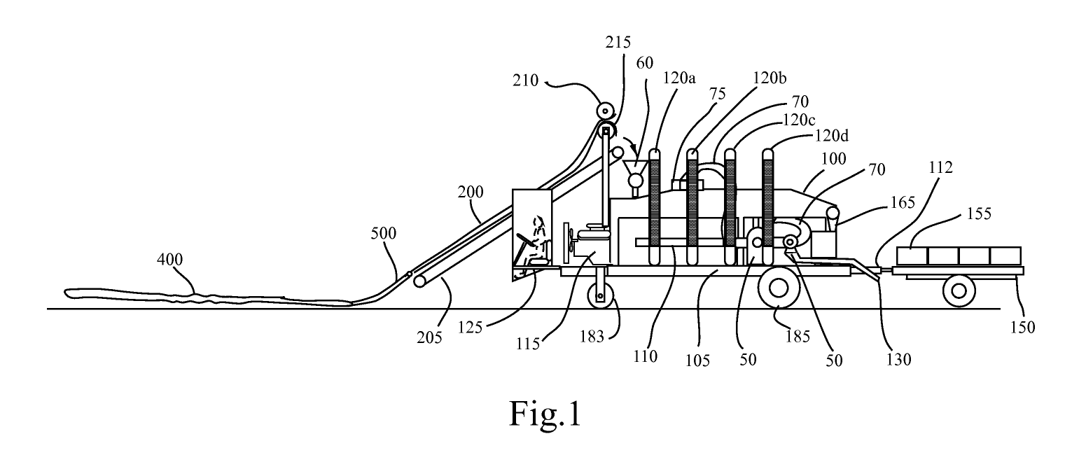

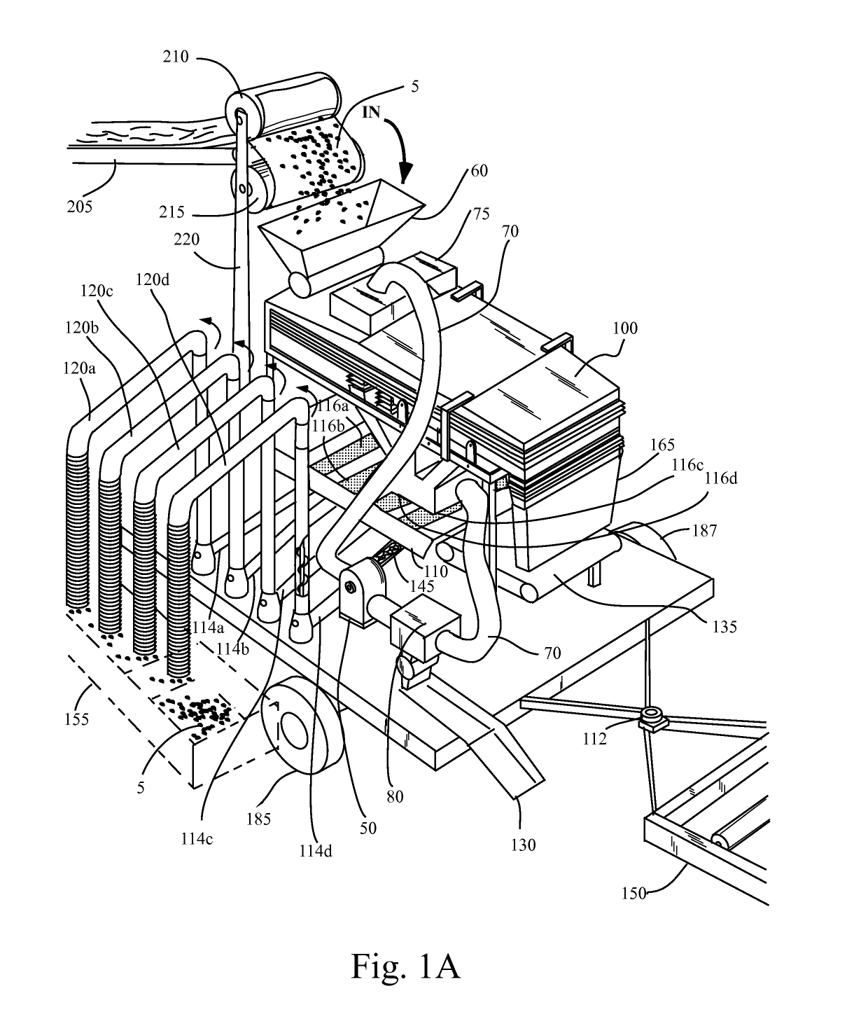

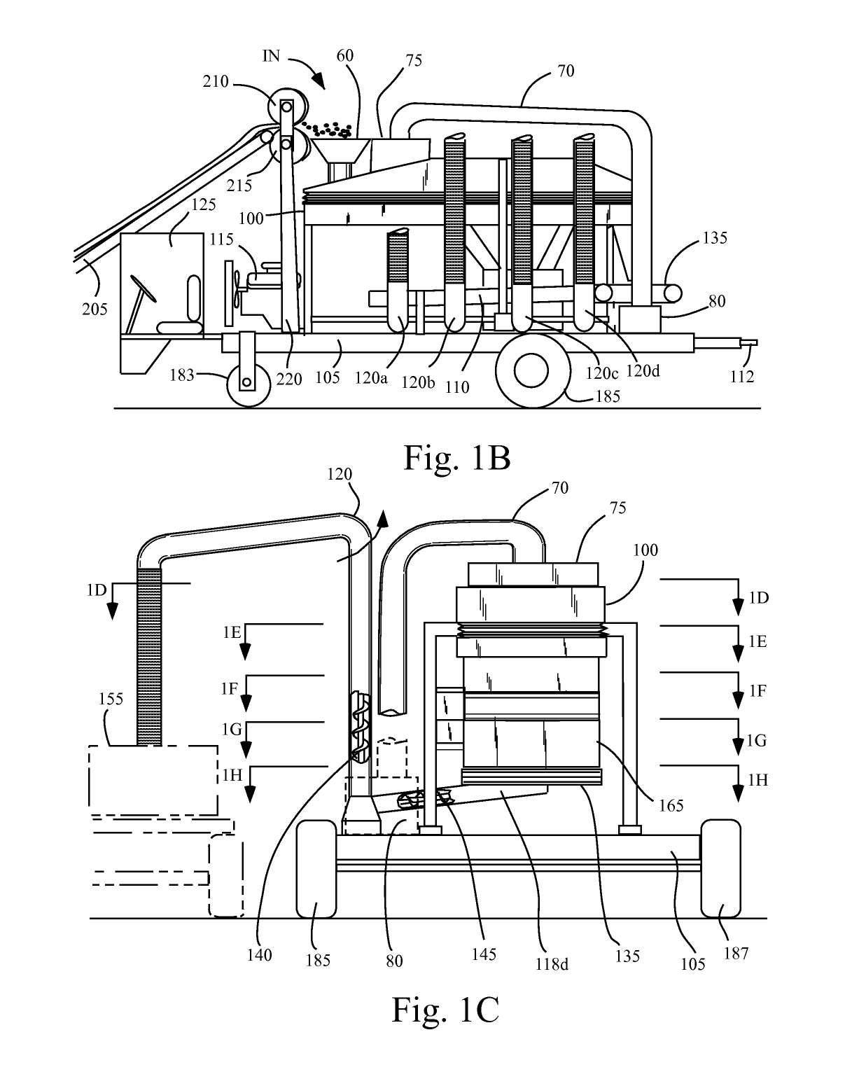

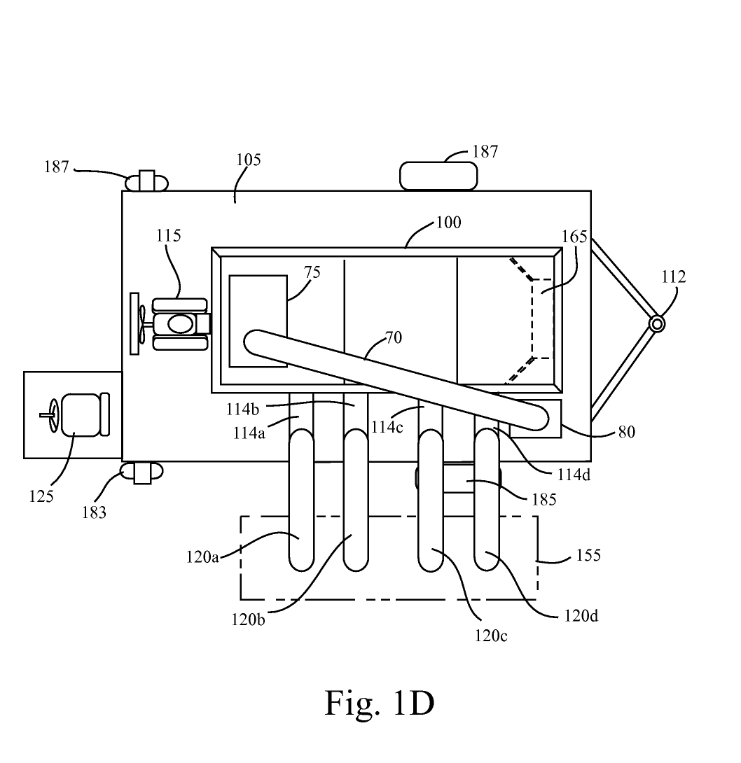

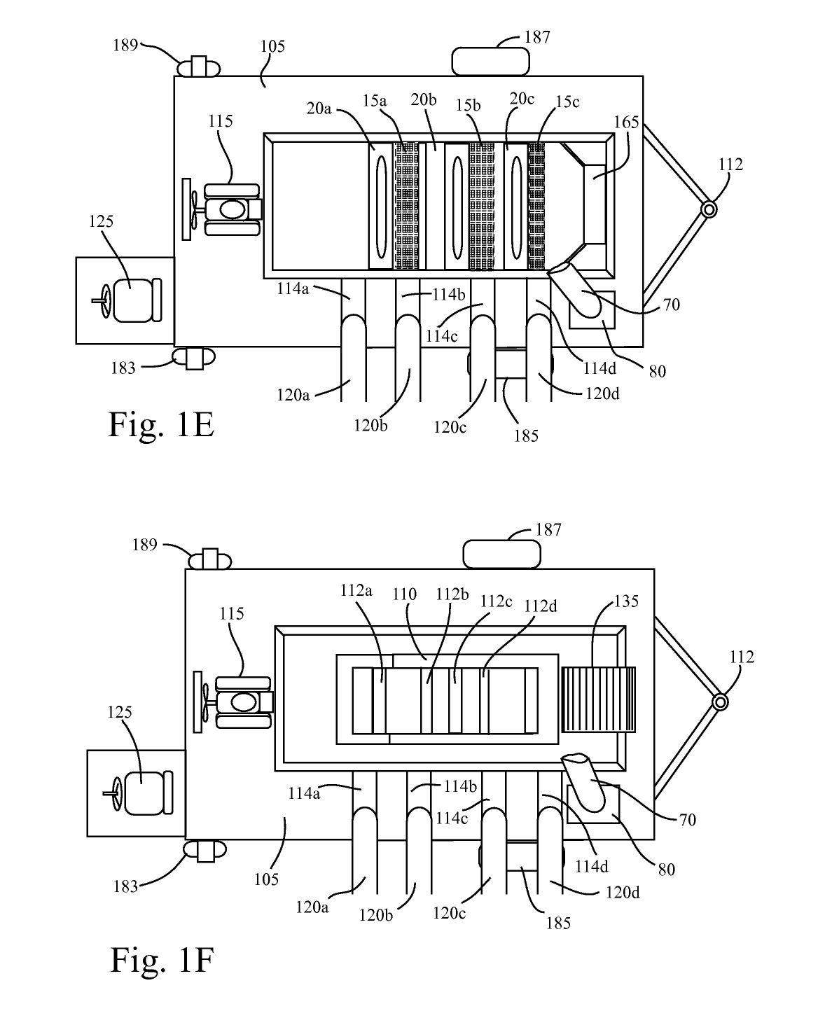

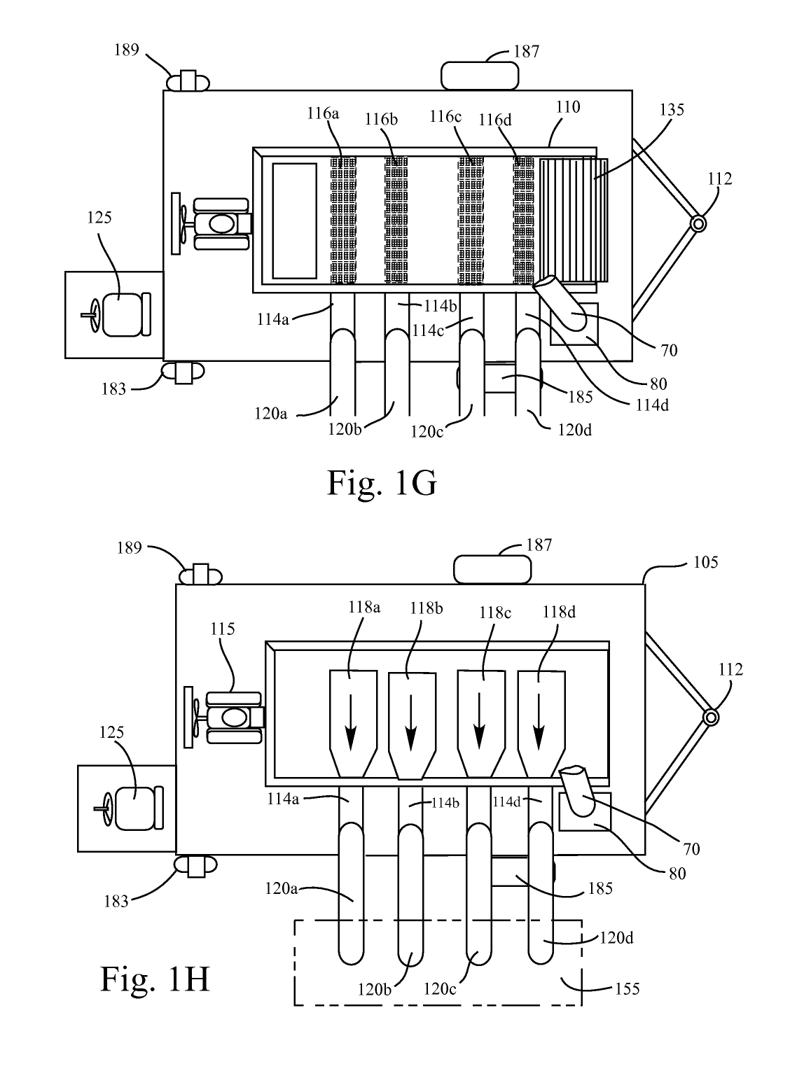

Referring to FIG. 1 a generalized side view of an embodiment of a mobile agricultural product treatment system 105 is depicted. The agricultural product treatment system 105 includes a pneumatic cleaning unit 100, a vibratory sorting unit 110, an agricultural product transport unit 205, and a power train 115. The pneumatic cleaning unit 100 is used to remove contaminates such as dirt, leaves, stems, twigs and other detritus from the untreated agricultural product. The untreated agricultural product is received by an inlet hopper 60 coupled to an intake associated with the pneumatic cleaning unit 100. The pneumatic cleaning unit 100 includes a series of internal reciprocating screen 15a-c (FIG. 1E) onto which agricultural product is delivered in a layer for travel across the screen. A top hood and a bottom hood are mounted in a substantially air-tight configuration about the screen. An air cleaner 80 is incorporated into a conduit 70 which receives forced air flow provided by an air blower 50.

Exhaust from the air blower 50 forces air through the agricultural product layer in a closed circuit with the air cleaner 80. Treated agricultural product is discharged from the pneumatic cleaning unit 100 by a discharge hopper 165. An embodiment of the pneumatic cleaning unit 100 is described in detail in U.S. Pat. No. 4,411,036, filed Nov. 16, 1981, to Mukai, who is also the instant inventor. U.S. Pat. No. 4,411,036 is hereby incorporated by reference in its entirety as if fully set forth herein.

The pneumatic cleaning unit 100 is mounted above a generally horizontal vibratory sorting unit 110 which receives the cleaned agricultural product from the discharge hopper 165. A suitable vibratory cleaning unit is available from Vaucher-Beguet, Model # TVETM 750, offered by Scott Laboratories, Inc.; 2220 Pine View Way, Petaluma, Calif. 94954. In an embodiment, a horizontal conveyor belt 135 (FIG. 1G) may be used to transport the treated agricultural product to the vibratory sorting unit 110. The vibratory sorting unit 110 includes a downward sloping table area 118 (FIG. 1F.) In an embodiment, the low point of the sloping table 118 is oriented towards the front of the agricultural product treatment system 105. A plurality of traverse screens 116a-d (FIG. 1E) having sequentially increasing mesh sizes are installed periodically at various longitudinal displacements in the surface of the sorting table area 118. The agricultural product falls through sorting screens during the sorting process into a series of collection conduits 114a-d (FIG. 1A) which feed a plurality of vertical screw conveyors 120a-d. Each of the vertical screw conveyors 120a-d raise the sorted agricultural product to a swivel joint 123a-d (FIG. 1A.) Each of the vertical screw conveyors 120a-d is longitudinally dimensioned to generally rise in height above the agricultural vegetation in proximity to the agricultural product treatment system 105. A suitable supplier for the vertical screw lift conveyors is Screw Conveyor Corporation, 7807 Doe Avenue, Visalia, Calif. 93291.

Each swivel coupling 123a-d connects to a generally horizontal conduit 122a-d (FIG. 1A). Each of the generally horizontal conduits 122a-d are sloped somewhat downward and away from the highpoint connection to the swivel couplings 123a-d to allow for gravity feed from the vertical screw conveyors 120a-d. In an embodiment, each of the horizontal conduits 122a-d is dimensioned to span across a row of agricultural vegetation. The swivel joints 123a-d allows the horizontal conduits 122a-d to be rotated about a vertical axis of each vertical screw conveyor 120a-d for positioning in the field. In an embodiment, flexible ducts 160a-d are coupled to the distal ends (low points) of the horizontal conduits 122a-d. The flexible ducts 160a-d allow field workers to relocate the discharge of the sorted agricultural product into collection bins 155 (FIG. 1A.)

A conveyor belt transfer system 205 is provided to transport the agricultural product from the ground level to an elevated level for discharge into the inlet hopper 60.

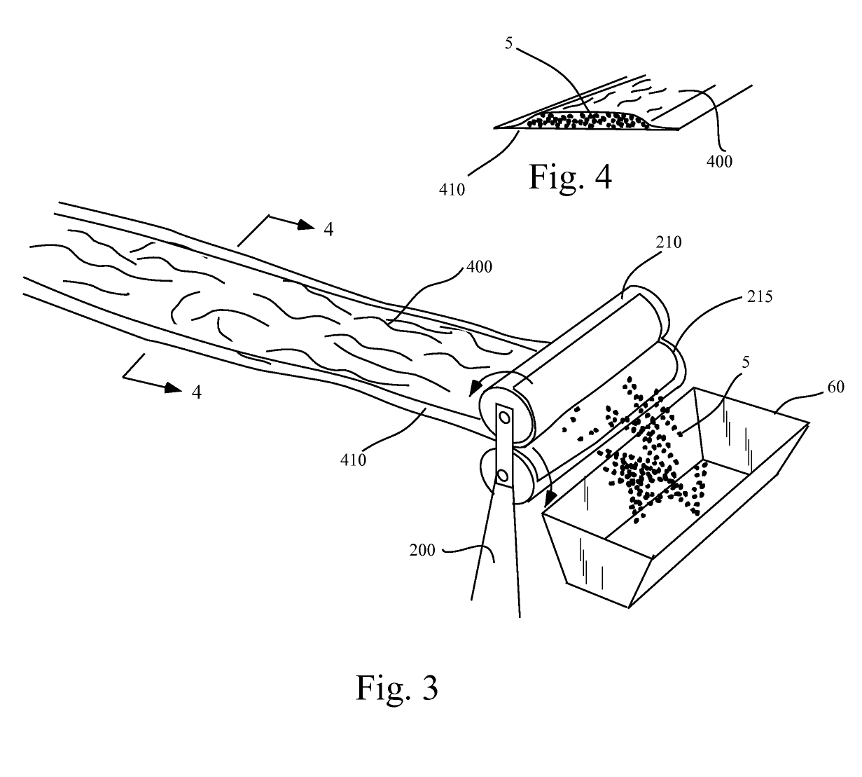

In an embodiment, the transport unit comprises the conveyor belt 205 and one or more spools 210, 215 transversely aligned to the conveyor belt 205 and supported by a pair of an elevated towers 220 installed on either side of the spools 210, 215. The spools 210, 215 may include a plurality of engagement spikes 225 (FIG. 3) which are used to pull the multi-layered elongated container 400 from the field, up the conveyor belt 205 where in an embodiment, one or more cutting blades 230 (FIG. 3) at least bifurcate an upper layer 400 and lower layer 410 of the multi-layered elongated container which are then wound on the spools 210, 215. As is discussed below, the materials used in the manufacture of the multi-layered elongated container 400 may be constructed from recyclable materials, allowing for waste reduction and simple recycling over traditional field treatment processes.

In an embodiment, the conveyor belt 205, may be provided with swiveled supports or articulating arms (not shown) which allow the conveyor belt 205 to be retracted above the pneumatic cleaning unit 100 during transport. In another embodiment, the conveyor belt 205 may be a separate unit mounted on a mobile platform which is towed by the agricultural cleaning and sorting unit 105, and positioned for operation in front of the agricultural cleaning and sorting unit 105.

In yet another embodiment, the conveyor belt 205 may be of a stair-step lift type conveyor belt which discharges the agricultural product directly into the inlet hopper 60. In this embodiment, the drives spools 210, 215 are not used. This embodiment of the invention allows the use of traditional field collection techniques while still gaining the advantages afforded by use of the agricultural product treatment system 105. Other components shown include the pneumatic ductwork 70 and pneumatic distribution header 75, and a driver's compartment 125.

The driver's compartment 125 is provided for driving and operating the agricultural cleaning and sorting unit 105. Motive force and self propulsion are provided in an embodiment by a fossil fueled engine 115. Motive force for the pneumatic cleaning unit 100, vibratory sorter 110, vertical screw lift conveyors 120a-d and other mechanical or electro-mechanical components may be driven by an electrical generator. Alternate embodiments of the invention may incorporate mechanical, pneumatic and/or hydraulically driven mechanisms as well. One skilled in the art will appreciate that various mechanical and electromechanical motive devices are well known and understood in the relevant art.

Referring to FIG. 1A an exemplary partial rear perspective view of an embodiment of the agricultural product treatment system 105 is provided. In the depicted embodiment, a multi-layered elongated container 400 is shown being retracted from the field using the conveyor belt 205 and retraction spools 210, 215. Each spool 210, 215 is configured to pull apart the various layers 400, 410 of the multi-layered elongated container 400 such that the agricultural product 5 retained with the multi-layered elongated container 400 is discharged into the inlet hopper 60. The agricultural product 5 is then pneumatically treated in the pneumatic cleaning unit 100. Closed circuit air flow is provided by the blower motor 50 which routes air flow through the air cleaner unit 80 and returned by a duct 70 to a multi-channel plenum 198. The multi-channel plenum 198 directs the air flow upward through the traveling layer of agricultural product 5 which removes lightweight debris for return through an upper collection header 75 and return duct 70 to be treated by the air cleaner unit 80. The cleaned agricultural product 5 is then discharged in an embodiment on to a forward rotating conveyor belt 135 for sorting by the vibratory sorting unit 110. The vibratory sorting unit 110 includes a plurality of screens 116a-d. The sorting screens 116a-d are arranged in increasing mesh size from backward to forward on the top surface 118.

The sorted agricultural product 5 falls through the appropriate screen mesh 116a-d and is collected in traverse and downwardly sloped transfer conduits 114a-d. In an embodiment, each transfer conduit 114a-d may include an internal transfer screw 195. In another embodiment, the sorted agricultural product 5 is fed into an associated vertical screw lift conveyor 120a-120d. The agricultural product 5 is then routed through the swivel joints 123a-d and into the horizontal conduits 122a-d. In an embodiment, the sorted agricultural product is discharged from the horizontal conduits 122a-d into flexible ducts 160a-d for collection in segregated bins 155.

Referring to FIG. 1B, a partial exemplary side view of the agricultural product treatment system 105 is provided. In addition to the components discussed above, an exemplary drive train 170 and gearbox 175 coupled to the engine 115 are provided as one exemplary mechanism in which motive force is provided to the various treatment and subunits.

Referring to FIG. 1C, a partial exemplary rear view of the agricultural product treatment system 105 is provided. Many of the subunits visible in previous views have been removed to illustrate certain features not clearly visible previously. The agricultural product treatment system 105 is divided into top view cross sectional views for illustration of the internals of the pneumatic cleaning unit 100 and vibratory sorting unit 110. This exemplary rear view of the agricultural product treatment system 105 provides the relationship of the discharge hopper 165 to the conveyor belt 135 used in an embodiment and associated with the vibratory sorting unit 110. A collection conduit 118 with an optional internal screw conveyor 195 is shown in transport continuity with the vertical screw conveyor 120, swivel joint 123, horizontal conduit 122 and flexible duct 150 for collection in a bin 155 on a transport trailer 150. An internal view 140 of the vertical screw mechanism of the vertical screw lifts 120a-d is provided as well.

Referring to FIG. 1D, an exemplary and partial top view of the agricultural product treatment system 105 is provided. In this exemplary view, the top of the pneumatic cleaning unit 100 includes the pneumatic distribution header 75, pneumatic ducting 70 and the cleaning unit 80. In an embodiment the air blower 50, is mounted vertically below the air cleaning 80 to maximize space savings and simplifying the routing of the air ducts 70. The engine 115 is shown in the front of the agricultural product treatment system 105 and its relation to the driver's cab 125. The engine 115 preferably has an unobstructed air ventilation path to allow cooling of an associated radiator 116. A top view of the horizontal conduits 122a-d is provided along with the collection conduits 114a-d which feed the vertical screw conveyors 120a-d (FIG. 1C.) The agricultural product treatment system 105 is steerably mounted on a mobile platform which allows the driver to steer the agricultural product treatment system 105 using the front wheels 185. For perspective purposes, an internal overview of the discharge hopper 165 is provided.

Referring to FIG. 1E, a partial top view of an embodiment of an mobile agricultural product treatment system 105 viewed from a level below the uppermost level is provided. In this exemplary view, the internal traveling screens 15a-c of the pneumatic cleaning unit 100 is depicted. A series of air manifolds 20a-c are provided to collect and remove lightweight debris from the agricultural product 5. The agricultural product 5 is directed toward the rear of the pneumatic cleaning unit 100 and down through the discharge hopper 165. The removed debris is air lifted and routed by ducts 70 to the air cleaner 80. For brevity, the descriptions of subunits already discussed are omitted.

Referring to FIG. 1F, a partial top view of an embodiment of the agricultural product cleaning system 105 viewed from two levels below the uppermost level is provided. In this exemplary view, the various ducts of the multi-channel plenum 198a-d are depicted above the vibratory sorting unit 110. As previously discussed, in an embodiment, a conveyor belt 135 is provided to transfer agricultural product 5 discharged from the discharge hopper 165 forward onto the top surface 118 of the vibratory sorting unit 110.

Referring to FIG. 1G, a partial top view of an embodiment of the agricultural product cleaning system 105 viewed from three levels below the uppermost level is provided. In this exemplary view, the various sorting screens 116a-d on the top surface 118 of the vibratory sorting unit 110 are depicted. In an embodiment, a vibratory motive unit 119 is provided at the front of the vibratory sorting unit 110 which causes deposited agricultural product 5 to move downward over the sorting screens 116a-d. The sorting screens 116a-d are arranged in increasing mesh size from backward to forward on the top surface 118. As previously discussed, in an embodiment, the conveyor belt 135 is provided to transfer agricultural product 5 discharged from the discharge hopper 165 forward onto the top surface 118 of the vibratory sorting unit 110.

Referring to FIG. 1H, a partial top view of an embodiment of the agricultural product cleaning system 105 viewed from four levels below the uppermost level is provided. In this exemplary view, the collection conduits 118a-d received the sorted agricultural product 5 sorted by the screens 116a-d of the vibratory sorting unit 110. In an embodiment, the collection conduits 118a-d are sloped downward to allow for gravity feeding of the vertical screw conveyors 120a-d. In an alternate embodiment, a screw conveyor 145 (FIG. 1C) may be included internally to the collection conduits 118a-d to ensure a consistent agricultural product feed-flow is maintained.

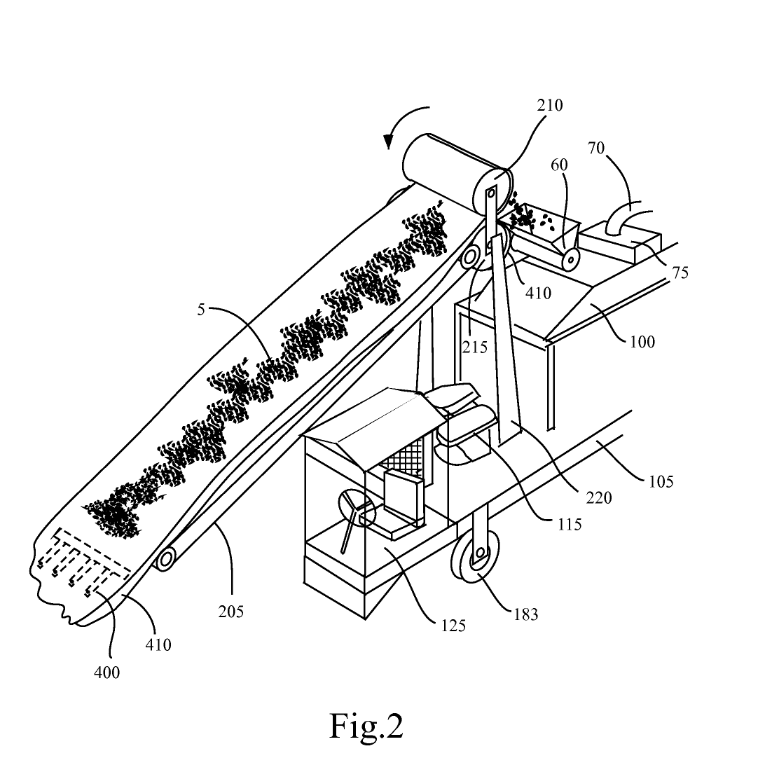

Referring to FIG. 2, an exemplary embodiment of the transport unit is depicted where a conveyor belt 205 is arranged to transfer agricultural product 5 contained in multi-layered elongated container 400 being retracted from the field. The top and bottom spools 210, 215 retraction motive force to at least bifurcate the top and bottom layers 400, 410 causing the agricultural product 5 to gravity feed the inlet hopper 60.

Referring to FIG. 3, an exemplary perspective view of the top and bottom spools 210, 215 is provided. In an embodiment, each spool 210, 215 may include a plurality of small spikes 225 to improve grasping of the multi-layered elongated container 400. A bifurcating cutting blade 230 is provided to assist in the splitting of the upper layer 400 from the lower layer 410 of the multi-layered elongated contained 400.

Referring to FIG. 4, a perspective cutaway view of the multi-layered elongated container 400 is depicted. The multi-layered elongated container 400 comprises a recyclable paper base 410 in which a clear plastic polymer 400 is attached. The plastic polymer 400 includes a plurality of small incisions or perforations 420 of sufficient size to allow air and moisture to be released from a cavity 415 formed between the paper base 410 and clear plastic polymer 400 but are insufficient in size to allow the agricultural product 5 contained within the cavity 415 to be released, similar to the retail packaging used for grapes and like items. Preferably, the clear plastic polymer 400 should be of a recyclable thermoplastic having an ultraviolet light protective additive incorporated therein. The dimensions of the cavity 415 are not critical so long as at least one or two layers of the agricultural product 5 may be stored therein. Preferably, the lateral dimension of the clear plastic polymer 400 should be slightly wider than that of the underlying paper 410 to allow the formation of the cavity 415. A thickness of 5-10 mils for each layer 400, 410 should be sufficient. The binding of the clear plastic polymer 400, for example polypropylene, to the paper base 410 may be accomplished by a variety means such as a thermal adhesive, periodic stitching, stapling or other methods known in the relevant art.

No specific limitation is intended to a particular systematic arrangement, component arrangement, component selection and/or particular construction materials. Other variations and embodiments are possible in light of above teachings, and it is not intended that this Detailed Description limit the scope of the inventive embodiments, but rather by the Claims following herein.

What is claimed:

1. An agricultural product cleaning system comprising:
an agricultural product transport unit having an outlet disposed above an inlet hopper coupled to a pneumatic cleaning unit;
said inlet hopper being configured to receive said agricultural product for delivery into an intake of said pneumatic cleaning unit;
said pneumatic cleaning unit being mounted superjacent to a vibratory cleaning unit and including a discharge hopper disposed above a longitudinal end of said vibratory cleaning unit;
said vibratory cleaning unit including a plurality of transversely aligned sorting screens disposed periodically along a generally horizontal longitudinal axis in sequentially increasing mesh sizes;
a plurality of declining and laterally aligned collection conduits mounted below said plurality of sorting screens and configured to receive sorted agricultural product; and,
a plurality of screw lift conveyers; each of said plurality of screw lift conveyers being coupled to a low end of each of said collection conduits; and,
wherein each of said plurality of screw lift conveyers comprises a generally vertical conduit rotationally coupled at an upper end to a generally declining horizontal conduit forming an inverted “L” shaped overhead product discharge duct for delivering said sorted agricultural product to a collection container.

2. The system according to claim 1 further including a motive force unit of sufficient capacity coupled to a drive train to provide said agricultural product cleaning system with at least self-propulsion.

3. The system according to claim 2 wherein said motive force unit further includes sufficient capacity to at least drive said pneumatic and said vibratory cleaning units.

4. The system according to claim 1 wherein said agricultural product transport unit comprises a first laterally mounted retraction spool disposed above said inlet hopper and means for at least bifurcating a multi-layered elongated container such that said agricultural product is gravity fed into said inlet hopper.

5. The system according to claim 4 wherein said multi-layered elongated container comprises a first layer of perforated polymeric material coupled to a base paper material such that an inner surface of said perforated polymeric material and a top surface of said base paper material forms a generally continuous compartment sufficient to maintain said agricultural product therein along a substantial length of said multi-layered elongated container.

6. The system according to claim 5 further including a second retraction spool laterally mounted below and generally in parallel to said first laterally mounted retraction spool; wherein said first retraction spool rotationally receives said perforated polymeric material and said second retraction spool rotationally receives said base paper material.

7. The system according to claim 1 wherein said agricultural product transport unit comprises an inclined stair-step conveyor belt configured to receive said agricultural product at a low end and transport said agricultural product to said outlet.

8. The system according to claim 4 wherein said agricultural product transport unit further comprises an inclined conveyor belt longitudinally aligned in a common axis with a direction of travel of said multi-layered elongated container.

9. The system according to claim 1 wherein said vibratory cleaning unit further includes a conveyor belt disposed below said discharge hopper and configured to longitudinally transport discharged agricultural product toward an opposite end of said vibratory cleaning unit.

10. The system according to claim 1 wherein said vibratory cleaning unit further includes a declination at least extending a longitudinal dimension which encompasses said plurality of sorting screens.

11. The system according to claim 1 wherein each of said generally declining horizontal conduits includes a generally vertically aligned flexible duct coupled to a discharge end of said generally declining horizontal conduit.

12. The system according to claim 4 wherein said means for bifurcating said multi-layered elongated container includes one of, a cutting blade, precut tear points in a layer of said multi-layered elongated container and a combination thereof.

13. The system according to claim 4 wherein said multi-layered elongated container comprises an elongated paper sheet base and a perforated clear plastic cover sheet affixed to said elongated paper sheet base such that said agricultural product is disposed there between for field drying.

14. An agricultural product cleaning system comprising:
a first laterally mounted retraction spool rotationally disposed above an inlet hopper;
said inlet hopper being configured to receive agricultural product transported by said at least one retraction spool for entry into an intake of a pneumatic cleaning unit;
said pneumatic cleaning unit being mounted superjacent to a vibratory cleaning unit and including a discharge hopper disposed above a longitudinal end of said vibratory cleaning unit;
said vibratory cleaning unit including a plurality of transversely aligned sorting screens disposed periodically along a generally declining horizontal longitudinal axis in sequentially increasing mesh sizes;
a plurality of laterally aligned and declining collection conduits mounted below said plurality of sorting screens configured to receive sorted agricultural product; and,
a plurality of screw lift conveyers; each of said plurality of screw lift conveyers being coupled at a low end of each of said collection conduits;
wherein each of said plurality of screw lift conveyers comprises a generally vertical conduit rotationally coupled at an upper end to a generally declining horizontal conduit forming an inverted “L” shaped overhead product discharge duct for delivering said sorted agricultural product to a collection container.

15. The system according to claim 14 further comprising a generally vertically aligned flexible duct coupled to a discharge end of said generally declining horizontal conduit.

16. The system according to claim 14 wherein said first laterally mounted retraction spool includes means for bifurcating a multi-layered elongated container such that said agricultural product is gravity fed into said inlet hopper.

17. The system according to claim 14 wherein said multi-layered elongated container comprises a first layer of perforated polymeric material coupled to a base paper material such that an inner surface of said perforated polymeric material and a top surface of said base paper material forms a generally continuous compartment sufficient to maintain said agricultural product therein along a substantial length of said multi-layered elongated container.

18. The system according to claim 17 further including a second retraction spool laterally mounted below and generally in parallel to said first laterally mounted retraction spool; wherein said first retraction spool rotationally receives said perforated polymeric material and said second retraction spool rotationally receives said base paper material.

19. The system according to claim 17 further comprising an inclined conveyor belt in juxtaposition to an axis in common with a direction of travel of said multi-layered elongated container.

20. The system according to claim 14 further comprising motive force means for at least one of: self propulsion, operation of said pneumatic cleaning unit, said vibratory sorting unit and said plurality of screw lift conveyers.
